(19) United States
(12) Patent Application Publication
(10) Pub. No.: US 2025/0292982 A1
(43) Pub. Date: Sep. 18, 2025

(54) ELECTRONIC SYSTEM, ELECTRONIC METHOD, AND NON-TRANSITORY COMPUTER READABLE MEDIUM

(71) Applicant: FUJIFILM Business Innovation Corp., Tokyo (JP)

(72) Inventors: Hideo ISHIZU, Kanagawa (JP); Toshitsugu KIKUCHI, Kanagawa (JP); Kodai UMEDA, Kanagawa (JP)

(73) Assignee: FUJIFILM Business Innovation Corp., Tokyo (JP)

(21) Appl. No.: 18/763,299

(22) Filed: Jul. 3, 2024

(30) Foreign Application Priority Data
Mar. 18, 2024 (JP) 2024-042739

(51) Int. Cl. H01H 50/02; H01H 47/00; H01H 50/08

(52) U.S. Cl. CPC H01H 50/021; H01H 47/002; H01H 50/08

(57) ABSTRACT

An electronic system includes: a mechanical electromagnetic relay configured to mechanically switch a contact according to application of current to a coil; and a processor configured to calculate, based on a number of operations of the contact of the mechanical electromagnetic relay and an index of electric power applied to the coil, a remaining service life of the mechanical electromagnetic relay; and transmit a notification indicating the calculated remaining service life of the mechanical electromagnetic relay.

### CROSS-REFERENCE TO RELATED APPLICATIONS

This application is based on and claims priority under 35 USC 119 from Japanese Patent Application No. 2024-042739 filed Mar. 18, 2024.

### BACKGROUND

### (i) Technical Field

The present disclosure relates to an electronic system, an electronic method, and a non-transitory computer readable medium.

### (ii) Related Art

In Japanese Unexamined Patent Application Publication No. 2011-210546, a relay service life estimation device that diagnoses the service life of a relay, based on the period of time from the point in time when application of current to the relay is started or the point in time when application of current to a relay coil by a controller is stopped to the point in time when the opening or closing of the relay is actually detected, is disclosed.

### SUMMARY

Mechanical electromagnetic relays that are configured to mechanically switch a contact according to application of current to a coil are used in various electronic systems. Such mechanical electromagnetic relays include a mechanical contact and thus typically have a short service life compared to other components mounted on an electronic system. Under such circumstances, in order to extend the service life of the entire electronic system, an operation such as replacing a mechanical electromagnetic relay with a new one needs to be performed when a certain period of time has passed. However, since the remaining service life of a mechanical electromagnetic relay mounted on an electronic system is largely impacted by the actual use condition of the electronic system or other factors, it is difficult to uniformly set the timing of replacing a mechanical electromagnetic relay with a new one. Thus, by allowing understanding of the remaining service life of a mechanical electromagnetic relay according to the actual use condition, the timing of replacing a mechanical electromagnetic relay with a new one may be able to be optimized for each electronic system.

Aspects of non-limiting embodiments of the present disclosure relate to providing an electronic system, an electronic method, and a non-transitory computer readable medium capable of allowing understanding of the remaining service life of a mechanical electromagnetic relay according to the actual use condition.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an electronic system including: a mechanical electromagnetic relay configured to mechanically switch a contact according to application of current to a coil; and a processor configured to calculate, based on a number of operations of the contact of the mechanical electromagnetic relay and an index of electric power applied to the coil, a remaining service life of the mechanical electromagnetic relay; and transmit a notification indicating the calculated remaining service life of the mechanical electromagnetic relay.

### BRIEF DESCRIPTION OF THE DRAWINGS

Exemplary embodiments of the present disclosure will be described in detail based on the following figures, wherein:

FIG. 1 is a diagram illustrating a system configuration of an image forming system according to an exemplary embodiment of the present disclosure;

FIG. 2 is a block diagram illustrating a hardware configuration of an image forming apparatus according to an exemplary embodiment of the present disclosure;

FIG. 3 is a diagram illustrating a circuit configuration of a FAX module;

FIG. 4 is a diagram illustrating an example of a remaining service life management table that a CPU stores in a nonvolatile memory;

FIG. 5 is a diagram for explaining an example of calculation of the remaining service life of a mechanical electromagnetic relay; and

FIG. 6 is a diagram illustrating an example of the situation in which a CPU of the image forming apparatus that has received a notification from the FAX module recommends, via a UI device, replacement of the FAX module.

### DETAILED DESCRIPTION

Hereinafter, exemplary embodiments of the present disclosure will be described in detail with reference to drawings.

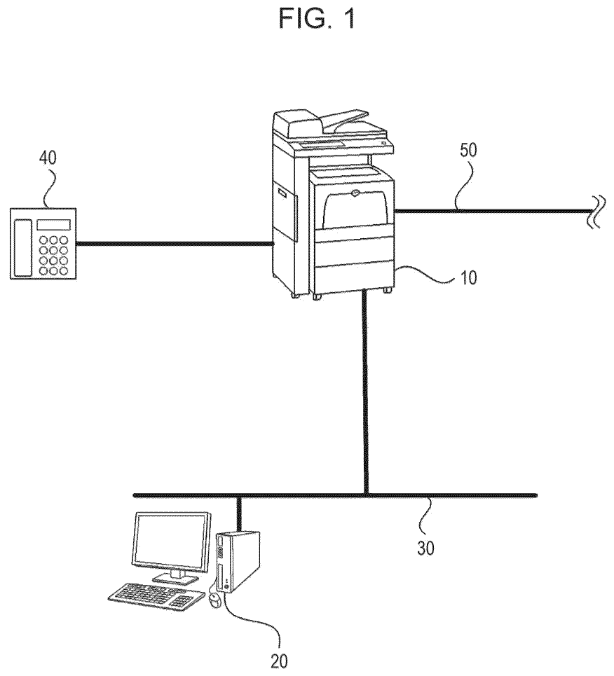

FIG. 1 is a diagram illustrating a system configuration of an image forming system according to an exemplary embodiment of the present disclosure.

As illustrated in FIG. 1, an image forming system according to an exemplary embodiment of the present disclosure includes an image forming apparatus 10, a terminal apparatus 20, and a telephone set 40 that is connected to the image forming apparatus 10. The image forming apparatus 10 and the terminal apparatus 20 are connected to each other by a network 30. The terminal apparatus 20 generates print data and transmits the generated print data to the image forming apparatus 10 via the network 30. The image forming apparatus 10 receives the print data transmitted from the terminal apparatus 20 and outputs an image corresponding to the print data onto paper. The image forming apparatus 10 is an apparatus that is called a so-called multifunction machine including multiple functions such as a printing function, a scan function, a copy function, and a facsimile function.

A telephone line 50 is connected to the image forming apparatus 10 so that facsimile transmission and reception is performed. In the system configuration illustrated in FIG. 1 in which the single telephone line 50 is shared by the telephone set 40 and the image forming apparatus 10, which is a facsimile apparatus, the telephone set 40 is connected to the image forming apparatus 10.

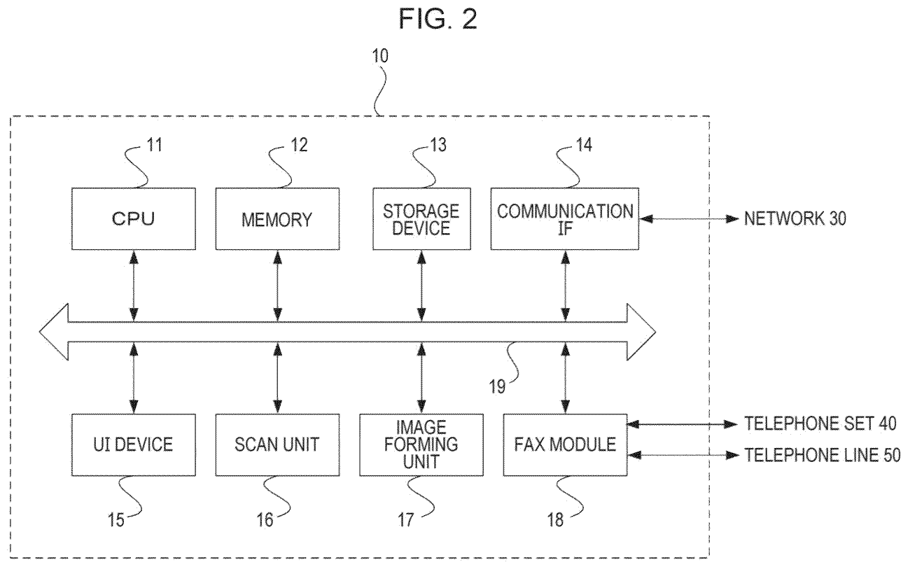

A hardware configuration of the image forming apparatus 10 in the image forming system according to an exemplary embodiment is illustrated in FIG. 2.

As illustrated in FIG. 2, the image forming apparatus 10 includes a central processing unit (CPU) 11, a memory 12, a storage device 13 such as a hard disk drive, a communication interface (IF) 14 that performs transmission and reception of data to and from an external apparatus via the network 30, a user interface (UI) device 15 including a touch panel or a liquid crystal display and a keyboard, a scan unit 16, an image forming unit 17, and a facsimile (FAX) module 18. The component elements mentioned above are connected to one another via a control bus 19.

The FAX module 18 is connected to the telephone line 50 and the telephone set 40. The FAX module 18 performs facsimile transmission and reception via the telephone line 50. The FAX module 18 also performs processing for connecting an incoming call from the telephone line 50 to the telephone set 40 and connecting an outgoing call from the telephone set 40 to the telephone line 50.

The CPU 11 is a processor that performs predetermined processing based on a control program stored in the memory 12 or the storage device 13 to control an operation of the image forming apparatus 10. In this exemplary embodiment, the CPU 11 has been described as a unit that reads the control program stored in the memory 12 or the storage device 13 and executes the control program. However, the CPU 11 is not limited to the one described above. The control program may be recorded in a computer-readable recording medium and provided. For example, the program may be recorded in an optical disc such as a compact disc-read only memory (CD-ROM) or a digital versatile disc-read only memory (DVD-ROM) or in a semiconductor memory such as a universal serial bus (USB) memory or a memory card and provided. Furthermore, the control program may be acquired from an external apparatus via a communication line connected to the communication IF 14. Moreover, for example, the control program may be provided as a single piece of application software or may be incorporated as a function of the image forming apparatus 10 into software of each apparatus.

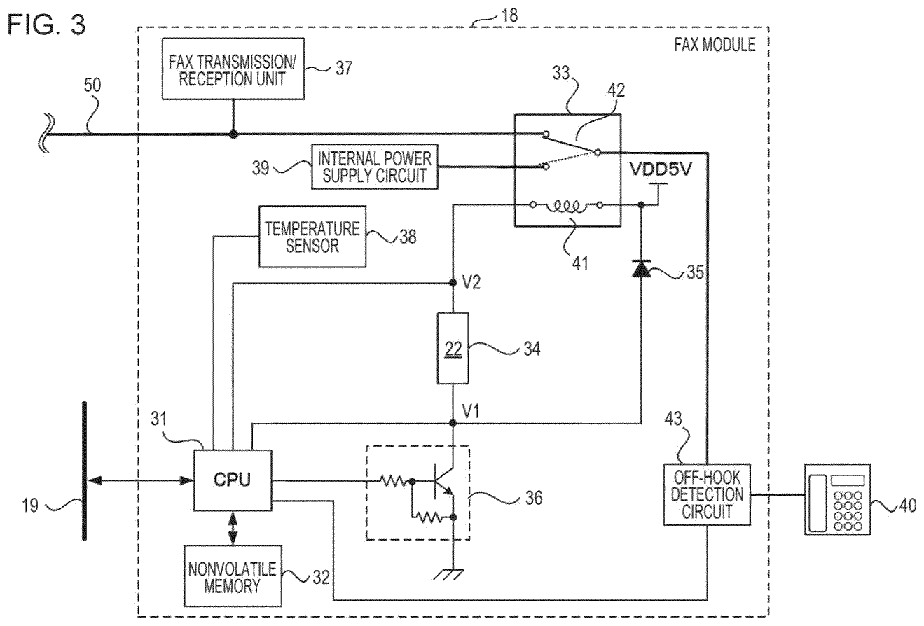

Next, a circuit configuration of the FAX module 18 will be described with reference to FIG. 3.

As illustrated in FIG. 3, the FAX module 18 according to this exemplary embodiment includes a CPU 31, a nonvolatile memory 32, a mechanical electromagnetic relay 33, a precision resistor 34, a diode 35, a digital transistor 36, a FAX transmission/reception unit 37, a temperature sensor 38, an internal power supply circuit 39, and an off-hook detection circuit 43.

The mechanical electromagnetic relay 33 includes a coil 41 and a single-pole double-throw contact part 42. The mechanical electromagnetic relay 33 is configured such that connection of the contact part 42 is mechanically switched according to application of current to the coil 41. Specifically, a line to the telephone set 40 is connected to the telephone line 50 in the case where current is not applied to the coil 41, and a line to the telephone set 40 is connected to the internal power supply circuit 39 in the case where current is applied to the coil 41.

One end of the coil 41 is connected to VDD 5V, which is a power supply voltage, and the other end of the coil 41 is connected to the digital transistor 36, which is a switching element, with the precision resistor 34 of 22Ω interposed therebetween. The digital transistor 36 is connected between the precision resistor 34 and the ground. Thus, when the CPU 31 turns on the digital transistor 36, the other end of the coil 41 is connected to the ground potential via the precision resistor 34 and enters a current applied state. The diode 35 is connected to absorb counter electromotive voltage that is generated when current is applied to the coil 41.

In a normal condition in which there is neither an outgoing call from the telephone set 40 nor an incoming call from the telephone line 50, the CPU 31 turns on the digital transistor 36 so that the telephone set 40 is disconnected from the telephone line 50 and is connected to the internal power supply circuit 39. Then, when the telephone set 40 enters an off-hook state, the off-hook state is detected by the off-hook detection circuit 43. When the off-hook detection circuit 43 detects that the telephone set 40 has entered the off-hook state, the CPU 31 turns off the digital transistor 36 and causes the coil 41 to enter the current applied state so that the telephone set 40 is connected to the telephone line 50.

The mechanical electromagnetic relay 33 configured as described above, which includes the mechanical contact part 42, typically has a short service life compared to other components mounted on the image forming apparatus 10. Thus, in order to extend the service life of the entire image forming apparatus 10, an operation such as replacing the FAX module 18 including the mechanical electromagnetic relay 33 with a new one needs to be performed when a certain period of time has passed. However, the remaining service life of the mechanical electromagnetic relay 33 mounted on the image forming apparatus 10 is largely impacted by the actual use condition of the image forming apparatus 10 or other factors. For example, in the case of a user who has a telephone line dedicated to facsimile and a telephone line dedicated to telephone separately, the number of operations of the contact part 42 of the mechanical electromagnetic relay 33 for the use of the telephone is small. Thus, it is difficult to uniformly set the timing of replacing the FAX module 18 with a new one. However, by allowing understanding of the remaining service life of the mechanical electromagnetic relay 33 according to the actual use condition, the timing of replacing the FAX module 18 with a new one may be able to be optimized for each image forming apparatus 10.

Thus, in the FAX module 18 of the image forming apparatus 10 according to this exemplary embodiment, understanding of the remaining service life of the mechanical electromagnetic relay 33 according to the actual use condition is possible by using a method described below.

The CPU 31 calculates the remaining service life of the mechanical electromagnetic relay 33, based on the number of contact operations, which is the number of times that the contact part 42 of the mechanical electromagnetic relay 33 was operated, and an index of electric power applied to the coil 41, and notifies a user of the obtained remaining service life of the mechanical electromagnetic relay 33.

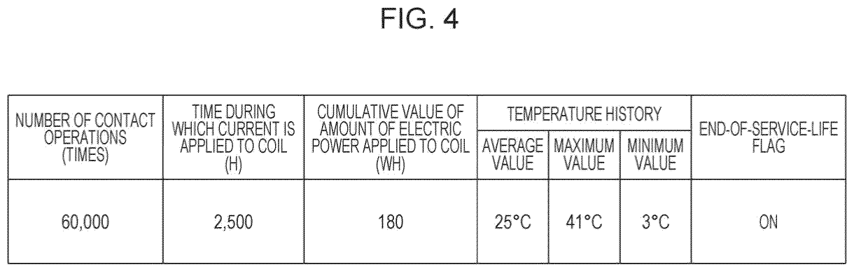

The CPU 31 stores a remaining service life management table illustrated in FIG. 4 in the nonvolatile memory 32 and determines, with reference to the remaining service life management table, how long the remaining service life of the mechanical electromagnetic relay 33 will be and whether it is at the end of the service life.

Specifically, as illustrated in FIG. 4, in the remaining service life management table, the number of times that the contact part 42 was operated is stored as the number of contact operations. Causes for breakdown of the mechanical electromagnetic relay 33 include welding of a contact of the contact part 42. Welding of the contact is more likely to occur as the number of contact operations increases. Since the CPU 31 outputs a signal for turning on the digital transistor 36, the CPU 31 counts, as the number of contact operations, the number of times that the signal was output, and stores the obtained number of contact operations into the remaining service life management table.

Furthermore, in the remaining service life management table illustrated in FIG. 4, the cumulative value of the time during which current was applied to the coil 41 and the cumulative value of the amount of electric power applied to the coil 41 are stored. The CPU 31 monitors a potential V1 at the point of connection between the precision resistor 34 and the digital transistor 36 and a potential V2 at the point of connection between the precision resistor 34 and the coil 41. Then, the CPU 31 counts the cumulative value of the time during which the potential between the potential V1 and the ground was 0.3 V by using, for example, a timer IC and stores the obtained cumulative value as the time during which current was applied to the coil 41 into the remaining service life management table.

Furthermore, the CPU 31 accumulates, based on the potential Vf between the potential V1 and the potential V2, the cumulative value of the amount of electric power applied to the coil 41 and stores the obtained value into the remaining service life management table. Specifically, the amount of electric power P applied to the coil 41 is calculated based on the product VI of the current I flowing in the coil 41 and the voltage V across the coil 41.

In the case where the voltage between the emitter and collector of the digital transistor 36 when the digital transistor 36 is in the ON state is ignored, the voltage V across the coil 41 is expressed by 5-Vf. Furthermore, the current I flowing in the coil 41 is calculated using an equation I=Vf/22 (Ω). Thus, the amount of electric power P applied to the coil 41 is able to be calculated using an equation:

$$P = VI = ( 5 - Vf ) \cdot Vf / 22 ( W ) .$$

As described above, the CPU 31 calculates, using the precision resistor 34, which is a resistor element connected between the coil 41 and the ground, the amount of electric power applied to the coil 41. Specifically, the CPU 31 calculates, based on the potential across the precision resistor 34, the value of the power supply voltage applied to the coil 41, and the resistance value of the precision resistor 34, the amount of electric power applied to the coil 41.

The CPU 31 stores the cumulative value of the amount of electric power applied to the coil 41 calculated as described above into the remaining service life management table.

In the example of the remaining service life management table illustrated in FIG. 4, information indicating that the number of contact operations is 60,000, the time during which current was applied to the coil is 2,500 hours (H), and the cumulative value of the amount of electric power applied to the coil is 180 Watt-hour (WH), and temperature history information indicating that the average value is 25 degrees Celsius, the maximum value is 41 degrees Celsius, and the minimum value is 3 degrees Celsius are stored. An end-of-service-life flag in the remaining service life management table indicates that the remaining service life of the mechanical electromagnetic relay 33 is less than a preset value. A specific example of switching on/off of the end-of-service-life flag will be described later.

The CPU 31 calculates the remaining service life of the mechanical electromagnetic relay 33 by comparing a value obtained by multiplying the number of contact operations, which is the number of times that the contact of the mechanical electromagnetic relay 33 was operated, by a coefficient determined based on an index of the electric power applied to the coil 41, with a durability upper limit value of the number of contact operations of the mechanical electromagnetic relay 33.

The durability upper limit value of the number of contact operations represents the average value of the number of operations of the contact part 42 of the mechanical electromagnetic relay 33 until occurrence of abnormality such as breakdown and is an upper limit value of the number of operations set by each manufacturer. For example, in the description provided below, the case where the durability upper limit value of the number of contact operations of the mechanical electromagnetic relay 33 is 100,000 will be described.

As an index of electric power applied to the coil 41, for example, the cumulative value of the time during which current was applied to the coil 41 described above may be used. Furthermore, the cumulative value of the amount of electric power applied to the coil 41 calculated using the precision resistor 34 by the method described above may be used as the index of electric power applied to the coil 41.

Furthermore, the FAX module 18 includes the temperature sensor 38 that measures the environmental temperature of the mechanical electromagnetic relay 33. Thus, the CPU 31 may calculate the remaining service life of the mechanical electromagnetic relay 33, based on temperature history information on the mechanical electromagnetic relay 33 measured by the temperature sensor 38 as well as the information on the number of contact operations of the contact part 42 and the index of electric power applied to the coil 41.

As the temperature history information on the mechanical electromagnetic relay 33, the average value of the environmental temperature of the mechanical electromagnetic relay 33 may be used or the maximum value or the minimum value of the environmental temperature of the mechanical electromagnetic relay 33 may be used.

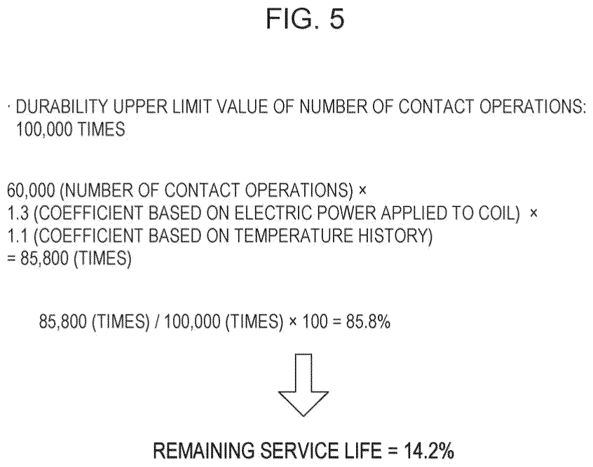

An example of calculation of the remaining service life of the mechanical electromagnetic relay 33 described above is illustrated in FIG. 5.

In the calculation example illustrated in FIG. 5, the durability upper limit value of the number of contact operations is 100,000. In addition, the current number of contact operations is 60,000, a coefficient based on electric power applied to the coil is 1.3, and a coefficient based on temperature history is 1.1.

The coefficient based on electric power applied to the coil is a coefficient that increases, such as 1.0, 1.1, 1.2, 1.3, and so on as the index of electric power applied to the coil, such as the cumulative value of the time during which current was applied to the coil or the cumulative value of the amount of electric power applied to the coil, increases. Furthermore, the coefficient based on temperature history is a coefficient that increases as the average value of the environmental temperature under which the mechanical electromagnetic relay 33 was used increases or a coefficient that increases as the maximum value of the environmental temperature under which the mechanical electromagnetic relay 33 was used increases or as the minimum value of the environmental temperature under which the mechanical electromagnetic relay 33 was used decreases. That is, since a higher average value of the environmental temperature under which the mechanical electromagnetic relay 33 was used indicates that the mechanical electromagnetic relay 33 was used in severer environments, a larger value is set as the coefficient based on temperature history. Furthermore, since a higher maximum value of the environmental temperature under which the mechanical electromagnetic relay 33 was used or a lower minimum value of the environmental temperature under which the mechanical electromagnetic relay 33 was used indicates that the mechanical electromagnetic relay 33 was used in severer environments, a larger value is set as the coefficient based on temperature history.

In the calculation example illustrated in FIG. 5, the value 85,800 is calculated using a calculation formula 60,000×1.3×1.1. Thus, for example, by dividing 85,800 by 100,000, which is the durability upper limit value of the number of contact operations, the CPU 31 calculates, based on use history up to the current time, how much time has passed out of the service life of the mechanical electromagnetic relay 33. Then, the CPU 31 calculates the remaining service life for the case where the service life of the mechanical electromagnetic relay 33 is set to 100%. Specifically, the CPU 31 obtains, as the remaining service life, the value 14.2%, which is obtained by subtracting 85.8%, which is obtained by the calculation described above, from 100%, which is the entire service life period.

For example, in the case of settings in that the end-of-service-life flag is turned on when the remaining service life reaches below 20% of the entire service life period, the CPU 31 performs switching of the end-of-service-life flag, based on the calculated value of the remaining service life. As is clear from the example of the remaining service life management table illustrated in FIG. 4, the end-of-service-life flag is turned on when the remaining service life becomes 14.2%.

Then, when the end-of-service-life flag, which is based on the calculated remaining service life, is turned on, the CPU 31 notifies the CPU 11 of the image forming apparatus 10, via the control bus 19, of information indicating that the remaining service life of the FAX module 18 has become short and the value of the remaining service life.

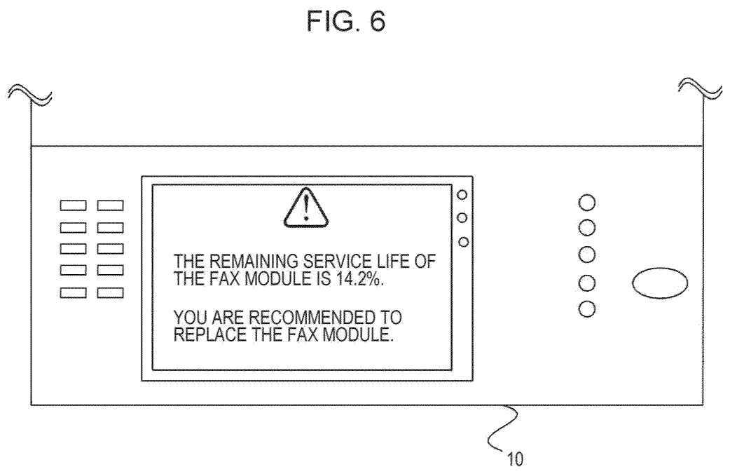

After that, the CPU 11 notifies the user, via the UI device 15, of information indicating that the remaining service life of the FAX module 18 has become short and replacement of the FAX module 18 will be necessary shortly and the remaining service life of the FAX module 18, and recommends the user to replace the FAX module 18. An example of the situation in which the CPU 11 of the image forming apparatus 10 that has received a notification from the FAX module 18 recommends, via the UI device 15, replacement of the FAX module 18 is illustrated in FIG. 6.

Referring to FIG. 6, text “The remaining service life of the FAX module is 14.2%. You are recommended to replace the FAX module.” is displayed on an operation panel of the image forming apparatus 10. The user who sees the display is able to understand the remaining service life of the FAX module mounted on the image forming apparatus 10 and understand that the FAX module needs to be replaced.

In an exemplary embodiment, the case where the remaining service life of the mechanical electromagnetic relay 33 is estimated by the CPU 31 inside the FAX module 18 has been described. However, the remaining service life management table illustrated in FIG. 4 may be stored in the image forming apparatus 10, and the CPU 11 of the image forming apparatus 10 may be configured to be capable of estimating the remaining service life of the mechanical electromagnetic relay 33. However, with the configuration in which the remaining service life management table is held in the FAX module 18, even if the FAX module 18 is moved onto another image forming apparatus, history information on the previous use conditions may be handed over.

The term “system” used in an exemplary embodiment includes both a system including a plurality of apparatuses and a system formed of a single apparatus.

### MODIFICATIONS

In an exemplary embodiment described above, the image forming system has been described as an example of an electronic system provided with a mechanical electromagnetic relay. However, the present disclosure is not limited to the image forming system. The present disclosure is also applicable in a similar manner to any electronic system that is provided with a mechanical electromagnetic relay, such as an acoustic system or a video system.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))

An electronic system comprising:
a mechanical electromagnetic relay configured to mechanically switch a contact according to application of current to a coil; and
a processor configured to:
   calculate, based on a number of operations of the contact of the mechanical electromagnetic relay and an index of electric power applied to the coil, a remaining service life of the mechanical electromagnetic relay; and
   transmit a notification indicating the calculated remaining service life of the mechanical electromagnetic relay.
      (((2)))

The electronic system according to (((1))), wherein the processor is configured to calculate the remaining service life of the mechanical electromagnetic relay by comparing a value obtained by multiplying the number of operations of the contact of the mechanical electromagnetic relay by a coefficient determined based on the index of the electric power applied to the coil with a durability upper limit value of the number of operations of the contact of the mechanical electromagnetic relay.

(((3)))

The electronic system according to (((2))), wherein the index of the electric power applied to the coil is a cumulative value of a time during which the current is applied to the coil.

(((4)))

The electronic system according to (((2))), further comprising:
a resistor element that is connected between the coil and a ground,
wherein the processor is configured to:
   calculate, based on a potential across the resistor element, a value of power supply voltage applied to the coil, and a resistance value of the resistor element, an amount of the electric power applied to the coil; and
   set the calculated cumulative value of the amount of electric power as the index of the electric power applied to the coil.
      (((5)))

The electronic system according to any one of (((1))) to (((4))), further comprising:
a temperature sensor configured to measure environmental temperature of the mechanical electromagnetic relay,
wherein the processor is configured to calculate, further based on temperature history information on the mechanical electromagnetic relay measured by the temperature sensor, the remaining service life of the mechanical electromagnetic relay.
   (((6)))

The electronic system according to (((5))), wherein the temperature history information on the mechanical electromagnetic relay is an average value of the environmental temperature of the mechanical electromagnetic relay.

(((7)))

The electronic system according to (((5))), wherein the temperature history information on the mechanical electromagnetic relay is a maximum value or a minimum value of the environmental temperature of the mechanical electromagnetic relay.

(((8)))

A program for causing a computer to execute:
calculating, based on a number of operations of a contact of a mechanical electromagnetic relay configured to mechanically switch the contact according to application of current to a coil and an index of electric power applied to the coil, a remaining service life of the mechanical electromagnetic relay; and
transmitting a notification indicating the calculated remaining service life of the mechanical electromagnetic relay.

What is claimed is:

1. An electronic system comprising:
a mechanical electromagnetic relay configured to mechanically switch a contact according to application of current to a coil; and
a processor configured to:
calculate, based on a number of operations of the contact of the mechanical electromagnetic relay and an index of electric power applied to the coil, a remaining service life of the mechanical electromagnetic relay; and
transmit a notification indicating the calculated remaining service life of the mechanical electromagnetic relay.

2. The electronic system according to claim 1, wherein the processor is configured to calculate the remaining service life of the mechanical electromagnetic relay by comparing a value obtained by multiplying the number of operations of the contact of the mechanical electromagnetic relay by a coefficient determined based on the index of electric power applied to the coil with a durability upper limit value of the number of operations of the contact of the mechanical electromagnetic relay.

3. The electronic system according to claim 2, wherein the index of the electric power applied to the coil is a cumulative value of a time during which the current is applied to the coil.

4. The electronic system according to claim 2, further comprising:
a resistor element that is connected between the coil and a ground,
wherein the processor is configured to:
calculate, based on a potential across the resistor element, a value of power supply voltage applied to the coil, and a resistance value of the resistor element, an amount of the electric power applied to the coil; and
set the calculated cumulative value of the amount of electric power as the index of the electric power applied to the coil.

5. The electronic system according to claim 1, further comprising:
a temperature sensor configured to measure environmental temperature of the mechanical electromagnetic relay,
wherein the processor is configured to calculate, further based on temperature history information on the mechanical electromagnetic relay measured by the temperature sensor, the remaining service life of the mechanical electromagnetic relay.

6. The electronic system according to claim 5, wherein the temperature history information on the mechanical electromagnetic relay is an average value of the environmental temperature of the mechanical electromagnetic relay.

7. The electronic system according to claim 5, wherein the temperature history information on the mechanical electromagnetic relay is a maximum value or a minimum value of the environmental temperature of the mechanical electromagnetic relay.

8. An electronic method comprising:
calculating, based on a number of operations of a contact of a mechanical electromagnetic relay configured to mechanically switch the contact according to application of current to a coil and an index of electric power applied to the coil, a remaining service life of the mechanical electromagnetic relay; and
transmitting a notification indicating the calculated remaining service life of the mechanical electromagnetic relay.

9. A non-transitory computer readable medium storing a program causing a computer to execute a process comprising:
calculating, based on a number of operations of a contact of a mechanical electromagnetic relay configured to mechanically switch the contact according to application of current to a coil and an index of electric power applied to the coil, a remaining service life of the mechanical electromagnetic relay; and
transmitting a notification indicating the calculated remaining service life of the mechanical electromagnetic relay.
